(19) United States
(12) Patent Application Publication
(10) Pub. No.: US 2006/0106491 A1
(43) Pub. Date: May 18, 2006

(54) Medication dispensing device

(76) Inventor: Stephen A. Kayner, Marcellus, MI (US)

Correspondence Address: PRICE HENEVELD COOPER DEWITT & LITTON, LLP, 695 KENMOOR, S.E., P O BOX 2567, GRAND RAPIDS, MI, 49501, US

(21) Appl. No.: 10/979,296

(22) Filed: Nov. 2, 2004

(51) Int. Cl. G06F 17/00

(52) U.S. Cl. 700/237

(57) ABSTRACT

A portable medication dispensing device having at least one memory unit, a fingerprint identification device, a display screen, one or more microswitches and a power source, which allows a specific patient access to a specific dose at specific time intervals is provided.

### BACKGROUND OF THE INVENTION

A portable medication dispensing device having at least one memory unit, a fingerprint identification device, a display screen, one or more microswitches and a power source, which allows a specific patient access to a specific dose at specific time intervals is provided.

Many different medication dispensing devices are known. U.S. Pat. No. 6,163,736 discloses a tamper resistant programmable medication dispenser. Such a device utilizes a controller associated with an indexing wheel, wherein the indexing wheel can be selectively moved so that doses of medication are supplied at varied intervals for each day of the week the dispenser is in use. U.S. Pat. No. 6,382,416 discloses a medication safety storage system, which restricts access to medicines to authorized persons who have pre-programmed a micro processor to recognize their unique fingerprint. The '416 device allows a person access to multiple doses and/or multiple medications. U.S. Pat. No. 6,415,202 discloses a tamper resistant programmable medicine dispenser. The '202 patent discloses a portable and tamper resistant electronically operated medication dispenser, which incorporates a programmable timer and a device assembly for selectively indexing a plurality of separate containers relative to a dispenser outlet. U.S. Pat. No. 6,662,081 discloses a medication regime container and system, which includes a holder for multiple storing and dispensing units in an ordered fashion consistent with the daily requirements of a medication regime.

Surprisingly, Applicant has newly discovered a portable medication dispensing device having at least one memory unit, a fingerprint identification device, a display screen, one or more microswitches and a power source, which allows a specific patient access to a specific dose at specific time intervals.

### SUMMARY OF THE INVENTION

One aspect of the present invention is a medication dispensing device having at least one memory unit, a fingerprint identification device, a display screen, one or more microswitches and a power source, which allows a specific patient access to a specific dose at specific time intervals.

These and other features, advantages, and objects of the present invention will be further understood and appreciated by those skilled in the art by reference to the following specification, claims, and appended drawings.

### BRIEF DESCRIPTION OF THE DRAWINGS

FIG. 1 is a front plan view of the medication dispensing device according to one aspect of the present invention;

FIG. 2 is a partial plan view of the medication dispensing device according to one aspect of the present invention; and

FIG. 3 is a partial exploded plan view of medication tubes and dispensing mechanism according to one aspect of the present invention.

### DETAILED DESCRIPTION OF PREFERRED EMBODIMENT

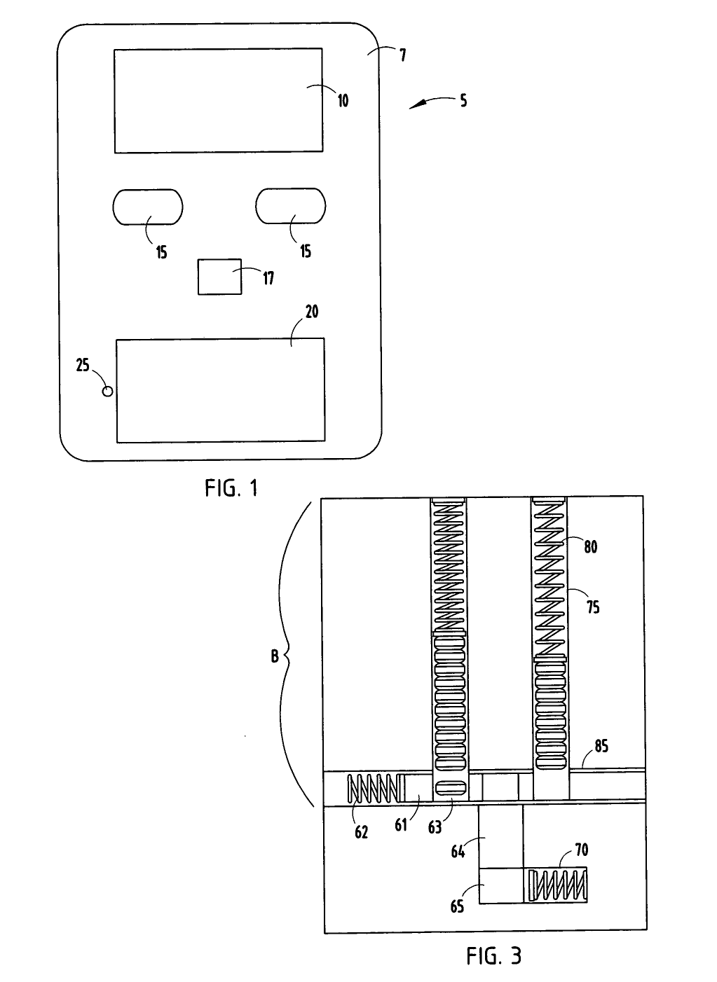

For purposes of description herein, the terms “upper,” “lower,” “right,” “left,” “rear,” “front,” “vertical,” “horizontal,” and derivatives thereof shall relate to the invention as oriented in FIG. 1. However, it is to be understood that the invention may assume various alternative orientations and step sequences, except where expressly specified to the contrary. It is also to be understood that the specific devices and processes illustrated in the attached drawings and described in the following specification are simply exemplary embodiments of the inventive concepts defined in the appended claims. Hence, specific dimensions and other physical characteristics relating to the embodiments disclosed herein are not to be considered as limiting.

The reference numeral 5 (FIG. 1) generally designates a portable medication dispensing device having at least one memory unit, a fingerprint identification device, a display screen, one or more microswitches and a power source, which allows a specific patient access to a specific medication dose at a specific time interval.

FIG. 1 generally depicts a front plan view of portable medication dispensing device 5. Portable medication dispensing device 5 includes a housing 7. Housing 7 may be any shape or size, however, a shape and size that fits securely within a user's hand and/or a shape and size that is easily portable and/or stowable within a user's bag, purse, etc. is preferred. Generally, the shape of housing 7 may include, but is not limited to, a generally rectangular shape, an oval shape, or any other geometric shape. Typically, a general rectangular shape, as shown in FIG. 1, is preferred. Housing 7 may be any size, including, but not limited to, a length of from about 2 inches to about 12 inches and a width of from about 2 inches to about 12 inches. Typically, a length range of from about 4 inches to about 7 inches and a width range of from about 2 inches to about 4 inches is preferred. Housing 7 may be comprised of any material, including, but not limited to, plastic, wood, metal or any combinations or derivations of any of the above. However, typically a plastic housing is preferred.

Within housing 7 is display screen 10. Display screen 10 is capable of showing various functions of portable medication dispensing device 5. Display screen 10 may include any type of display screen, including, but not limited to, an LED (light emitting diode) screen, a digital screen, a screen having analog dials, etc. or any combination of any of these types of displays. However, an LED screen is most typically preferred. It is conceivable that portable medication dispensing device may include one, two, three or more display screens, however, typically one display screen is preferred.

Housing 7 also typically includes one or more function buttons 15. Function buttons 15 may be used to access different functions of portable medication dispensing device 5, for example, to change modes, to light display screen 10, to open portable medication dispensing device 5, to refill portable medication dispensing device 5, and/or to program portable medication dispensing device 5, etc. Typically, function buttons 15 are in communication with display screen 10 and/or power source 55 and/or memory device 45. Typically, this communication is a wired communication, but a wireless communication is also acceptable. However, a wired communication is preferred.

Housing 7 also typically includes fingerprint identification scanner 20. Fingerprint identification scanner 20 is generally known in the art and is capable of scanning a fingerprint. Fingerprint identification scanner 20 is in communication with memory device 45 and/or power source 55 and/or second microswitch(s) 60.

Optionally, housing 7 may also include a recharging port 25, which is in communication with power source 55, and which may accept an insert capable of supplying rechargeable power to the power source 55.

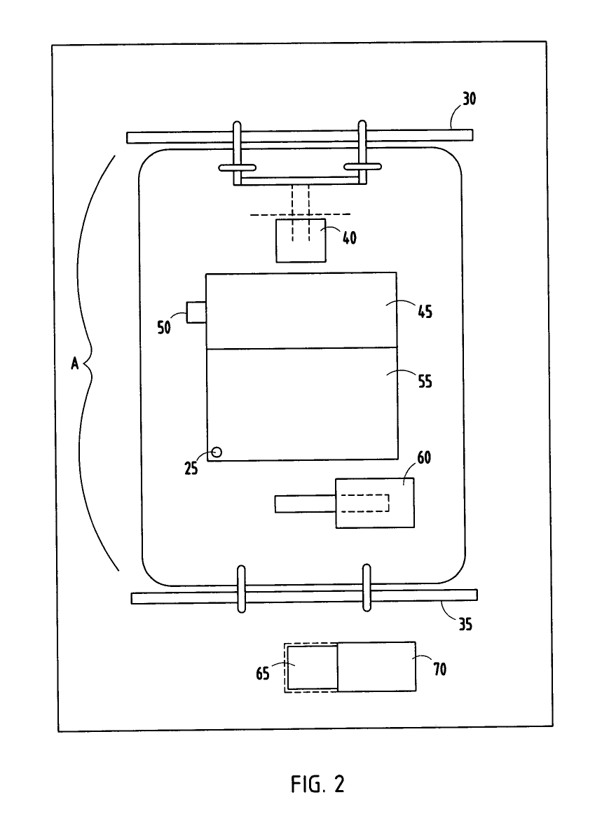

FIG. 2 generally depicts unit A of portable medication dispensing device 5. Unit A is generally held within portable medication dispensing device 5 via one or more first locking pin(s) 30 and one or more second locking pin(s) 35. Typically, these first locking pins 30 and second locking pins 35 are positioned generally parallel to one another but on opposite ends from one another of unit A. It is conceivable that the first locking pins 30 and second locking pins 35 may be in generally a perpendicular relationship to one another or both a parallel and a perpendicular relationship to one another, however, a parallel relationship is preferred.

Unit A includes a first microswitch which locks the unit B (see FIG. 3) onto unit A within portable medication dispensing device 5. First microswitch 40 is in communication with power source 55, fingerprint identification scan 20, and unit B. When a preprogrammed authorized user (a prescriber, a pharmacist, or other designated healthcare personnel) applies their finger to fingerprint identification scanner 20, fingerprint identification scanner 20 scans the respective user's fingerprint. Fingerprint identification scanner 20 is in communication with memory device 45. Memory device 45 is capable of holding multiple (i.e., two or more) fingerprints in its memory. When an authorized user's fingerprint is matched from the fingerprint identification scanner 20 with a fingerprint saved in the memory device 45 of portable medication dispensing device 5, first microswitch 40 is activated so that there is a release of unit B from unit A of the portable medication dispensing device 5. This release may be a partial release or a total release, so long as the authorized user can gain access to unit B to, for example, change the medication in unit B, refill medication in unit B, remove medication from unit B, or correct any malfunction in unit B, etc.

Memory device 45 is a device that may contain any and all information, including, but not limited to, fingerprints of both a patient and an authorized user of the portable medication dispensing device 5 (memory fingerprints), various calendar settings, including, but not limited to, month, date, time of day, and other periodic intervals, etc. The memory within memory device 45 is preferably a “hard memory” so as not to be affected by the loss of power. That is to say, if portable medication dispensing device 5 were to lose power for any reason, for any length of time, memory device 45 would retain any and all preprogrammed information. An authorized user may input and/or delete memory information from memory device 45, however, memory device 45 would not lose any of its preprogrammed information due to the loss of power. Memory device 45 may be any type of memory device, including, but not limited to a computer chip, another type of stored memory device, wherein the information saved in the memory is easily retrieved and in the case of a fingerprint compared to stored and/or scanned fingerprints.

Programming port 50 is used to program the memory stored within memory device 45. For example, an authorized user may place their finger on fingerprint identification scanner 20, press, twist, or otherwise activate preprogramming port 50 to capture the fingerprint of the authorized user and save it in the memory of memory device 45. Likewise, this may also be done with the patient that is to use portable medication dispensing device 5. Additionally, programming port 50 may also be used to enter any of the periodic dosage information, including, but not limited to, dosing intervals, to trigger optional audible alarm 17 (see FIG. 1), etc.

Unit A also includes power source 55. Power source 55 may be any type of power source, including, but not limited to, any type of battery, including, but not limited to, alkaline batteries, zero mercury batteries, rechargeable batteries, lithium diode batteries, or any other type of battery capable of storing the power necessary to operate the portable medication dispensing device 5. Power source 55 is in communication with recharging port 25.

Unit B (see FIG. 3), as mentioned above, typically includes one or more medication tubes 75, one or more removable tension springs 80, and one or more medication release areas 85. As can be seen in FIG. 3, medication tubes 75 are positioned in a generally perpendicular position relative to medication release area 85. Typically, in use, an authorized user will remove removable tension springs 80, insert the medication to be contained therein, and replace the removable tension springs 80. Removable tension springs 80 are held within medication tube 75 via any conceivable holding mechanism. As medication is released from medication tubes 75, removable tension springs 80 expand thereby maintaining an appropriate amount of pressure on the medications to advance them to openings 63 when necessary. Medication tubes 75 are in connection with medication release area 85. Medication release area 85 generally includes one or more second microswitches 60 (see FIG. 2), one or more microswitch actuated slides 61, return spring 62 and one or more openings 63 in slide 61. When activated, the one or more second microswitches 60 move microswitch actuated slide 61 across the opening of medication tubes 75. Microswitch actuated slide 61 has one or more openings 63 therein whereby when second microswitch 60 is activated, microswitch activated slide 61 is positioned in the appropriate position, medication will be pushed from medication tube 75 via removable tension spring 80 into the medication release area 85. At this time, second microswitch 60 then is activated a second time, or deactivated, depending on which tube 75 the medication is coming from allowing return spring 62 to push microswitch actuated slide 61 to a position that generally aligns the medication with one or more chutes 64, which lead to the medication retrieval area 65. The medication then falls down chute 64 to medication retrieval area 65. Medication retrieval area 65 includes a spring activated slidable door 70 covering medication retrieval area 65. Once the medication is dropped into medication retrieval area 65, a user may slide spring activated slidable door 70 to uncover the medication.

Device 5 is secure and only dosage medication may be retrieved by the patient. The device may also be accessed by an authorized health care professional for the reasons stated above.

In the foregoing description, it will be readily appreciated by those skilled in the art that modifications may be made to the invention without departing from the concepts disclosed herein.

The invention claimed is:

1. A medication dispensing device, comprising:
a housing;
a display screen;
a first programmable microswitch;
a memory device;
a function button;
a fingerprint identification scanner;
a second programmable microswitch;
a microswitch activated slide;
a medication tube;
a medication chute; and
a medication retrieval area from where generally one dose of a medication may be retrieved, wherein the device allows a specific patient access to a specific dose at a specific time interval.

2. The medication dispensing device of claim 1, wherein the display screen is an LED display screen.

3. The medication dispensing device of claim 1, wherein the display screen is a digital display screen.

4. The medication dispensing device of claim 2, wherein the memory device may store two or more fingerprints.

5. The medication dispensing device of claim 4, wherein the memory device may store calendar settings.

6. The medication dispensing device of claim 5, wherein the memory device has a hard memory.

7. A method of dispensing medication, comprising:
providing a medication dispensing device comprising:
a housing;
a display screen;
a first programmable microswitch;
a memory device;
a function button;
a fingerprint identification scanner;
a second programmable microswitch;
a microswitch activated slide;
a medication tube;
a medication chute; and
a medication retrieval area from where generally one dose of a medication may be retrieved, wherein the device allows a specific patient access to a specific dose at a specific time interval;
scanning a fingerprint on the fingerprint identification scanner;
comparing the scanned fingerprint with a memory fingerprint via the memory device;
activating the second programmable microswitch to align the microswitch activated slide with the medication tube and the medication chute retrieving a medication from the medication dispensing area.
